(19) United States
(12) Patent Application Publication
(10) Pub. No.: US 2007/0006583 A1
(43) Pub. Date: Jan. 11, 2007

(54) NANOTUBE ELECTRON EMISSION THERMAL ENERGY TRANSFER DEVICES

(75) Inventor: Anthony Frank Veneruso, Missouri City, TX (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 11/160,717

(22) Filed: Jul. 6, 2005

(51) Int. Cl. F02G 1/04

(52) U.S. Cl. 60/508

(57) ABSTRACT

A nanotube-based heat transfer device includes a substrate layer having a first conductive layer, wherein the substrate layer is adapted to conduct heat from an object to be cooled; a plurality of carbon nanotubes disposed on the first conductive layer; and an anode plate having a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes, wherein the first conductive layer and the second conductive layer are adapted to connect to a power source to provide a bias electrical potential for inducing electron emission from the plurality of carbon nanotubes.

### BACKGROUND OF INVENTION

1. Field of the Invention

The invention relates generally to thermoelectric heat transfer. More particularly, the invention relates to nanotube-based heat transfer devices.

2. Background Art

Increasingly, electronic components along with their associated circuits and systems are getting smaller, while their thermal power density and heat production are increasing. To avoid thermal damage, it is necessary to remove the heat generated by these devices by some appropriate thermal management or heat transfer means. Common “passive” heat transfer techniques are based on the physical principles of heat conduction, convection, or radiation. Unfortunately, cooling electronics downhole by these passive heat transfer techniques is difficult to accomplish because borehole environments typically experience high temperatures, as high as 150° C.

“Active” heat transfer techniques include compression-evaporation techniques and thermoelectric techniques. Compression-evaporation techniques are based on the fact that compression of a gas releases heat, while gas expansion absorbs heat. Compression-evaporation refrigerators tend to be bulky. Recently, a miniature compressor was developed at the University of Illinois. See Shannon, et al., “Integrated Mesoscopic Cooler Circuits (IMCCs),” 1999 ASME International Mechanical Engineering Congress and Exhibition, Nashville, Tenn., Nov. 15-20, 1999, Proceedings of the ASME, Advanced Energy System Division, AES-Vol. 39, p. 75-82. However, refrigerator approaches have all the drawbacks and problems inherent with moving parts and moving fluids.

Thermoelectric techniques are based on Peltier effects (see FIG. 1). Peltier effects relate to heat generation or removal when an electric current crosses a junction of two conductors having different Peltier coefficients. The magnitude of the heat removal is proportional to the magnitude of the current and the difference between the Peltier coefficients. Peltier modules are commonly made of bismuth telluride (e.g., Bi₂Te₃). The Peltier effect results from the fact that an electric current is accompanied by a heat current in a homogeneous conductor. When the conductive path is made of two conductors having different Peltier coefficients, one conductor may be better at conducting electric current than heat current (or vice versa), as compared to the other conductor. As a result, some thermal energy may be left behind at the junction, or some thermal energy may be removed from the junction when a current passes through the junction. Unfortunately, Peltier or thermoelectric devices are inefficient and, in addition, they tend to have short lives at high temperatures. See Moores et al., “Performance Assessment of Thermoelectric Coolers for Use in High Temperature electronics Applications,” Proceedings of the 18th IEEE International Conference on Thermoelectrics, Baltimore, Md., September 1999. These are some of the key drawbacks which prevent these devices from being successfully applied in logging and drilling tools.

U.S. Pat. No. 6,089,311 issued to Edelson discloses the use of thermionic vacuum diodes having very low work function electrodes to construct heat pumps. According to methods disclosed in this patent, a negative potential bias is applied to the cathode relative to the anode, and electrons are emitted. In the process of emission, the electrons carry off kinetic energy, carrying heat away from the cathode and dissipating it at an opposing anode.

Recently, researchers at Stanford University reported a nanometer-scale approach for refrigeration based on combined tunneling and thermionic emission in vacuum. See Hishinuma et al., “Refrigeration by Combined Tunneling and Thermionic Emission in Vacuum: Use of Nanometer Scale Design,” Applied Physics Letters, 78(17): 2572-74, 2001. A product based on “Electron Tunneling Through Large Area Vacuum Gap” is being commercialized under the trade name of Cool Chip™ by Cool Chips Plc. (Gibraltar). See Tavkhelidze et al., “Electron Tunneling Through Large Area Vacuum Gap-Preliminary Results,” ICT 2002 Conference Proceedings. In order for electron tunneling or thermionic emission to occur, the vacuum gap must be small (on the order of several nanometers). The fabrication and reliability of such devices presents a big challenge because it requires maintaining electrical insulation across extremely close-spaced (about 10 nanometers) metal plates over a relatively large surface area.

While the above described prior art devices are capable of providing cooling or heating in certain applications, there is still a need for heat transfer apparatus and methods that can provide more efficient heat transfer and are reliable at high temperatures.

### SUMMARY OF INVENTION

One aspect of the invention relates to nanotube-based heat transfer devices. A nanotube-based heat transfer device in accordance with one embodiment of the invention includes a substrate layer having a first conductive layer, wherein the substrate layer is adapted to conduct heat from an object to be cooled; a plurality of carbon nanotubes disposed on the first conductive layer; and an anode plate having a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes, wherein the first conductive layer and the second conductive layer are adapted to connect to a power source to provide a bias electrical potential for inducing electron emission from the plurality of carbon nanotubes.

One aspect of the invention relates to thermal energy management systems. A thermal energy management system in accordance with one embodiment of the invention includes a heat transfer assembly comprising a plurality of nanotube-based heat transfer devices; and a first heat exchanger coupled to the heat transfer assembly; wherein at least one of the plurality of nanotube-based heat transfer devices comprises: a substrate layer having a first conductive layer, wherein the substrate layer is adapted to conduct heat from an object to be cooled; a plurality of carbon nanotubes disposed on the first conductive layer; and an anode plate having a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes, wherein the first conductive layer and the second conductive layer are adapted to connect to a power source to provide a bias electrical potential for inducing electron emission from the plurality of carbon nanotubes.

One aspect of the invention relates to nanotube-based heat-driven engines. A nanotube-based heat-driven engine in accordance with one embodiment of the invention includes an engine comprising a fluid, wherein controlled cooling and heating of the fluid provides energy to run the engine; a cooling mechanism; and a heating mechanism, wherein at least one selected from the cooling mechanism and the heating mechanism comprises a carbon nanotube-based heat transfer device, wherein the carbon nanotube-based heat transfer device comprising: a substrate layer having a first conductive layer, wherein the substrate layer is adapted to conduct heat from an object to be cooled; a plurality of carbon nanotubes disposed on the first conductive layer; and an anode plate having a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes, wherein the first conductive layer and the second conductive layer are adapted to connect to a power source to provide a bias electrical potential for inducing electron emission from the plurality of carbon nanotubes.

One aspect of the invention relates to methods for heat transfer. A method for heat transfer in accordance with one embodiment of the invention includes placing a carbon nanotube-based heat transfer device in contact with an object, wherein the carbon nanotube-based heat transfer device comprises: a substrate layer having a first conductive layer, wherein the substrate layer is adapted to conduct heat from the object; a plurality of carbon nanotubes disposed on the first conductive layer; and an anode plate having a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes, wherein the first conductive layer and the second conductive layer are adapted to connect to a power source to provide a bias electrical potential for inducing electron emission from the plurality of carbon nanotubes; and applying a bias electrical potential across the first conductive layer and the second conductive layer of the carbon nanotube-based heat transfer device to induce electron emission from the plurality of the carbon nanotubes.

Other aspects and advantages of the invention will be apparent from the following description and the appended claims.

### BRIEF DESCRIPTION OF DRAWINGS

FIG. 1A shows a schematic of a prior art device illustrating the Peltier effect.

FIG. 2A shows a schematic of a nano-cooler in accordance with one embodiment of the invention.

FIG. 2B shows a cross sectional view of a nano-cooler in accordance with one embodiment of the invention.

FIGS. 3A-3C show enclosure structures for nano-coolers in accordance with embodiments of the invention.

FIGS. 4A and 4B show nano-coolers arranged in series in accordance with embodiments of the invention.

FIG. 5 shows a thermal management system using a stack of nano-coolers in accordance with one embodiment of the invention.

FIG. 6 shows a Sterling engine that can be used with nano-coolers of the invention.

FIG. 7 shows a method for heat transfer in accordance with one embodiment of the invention.

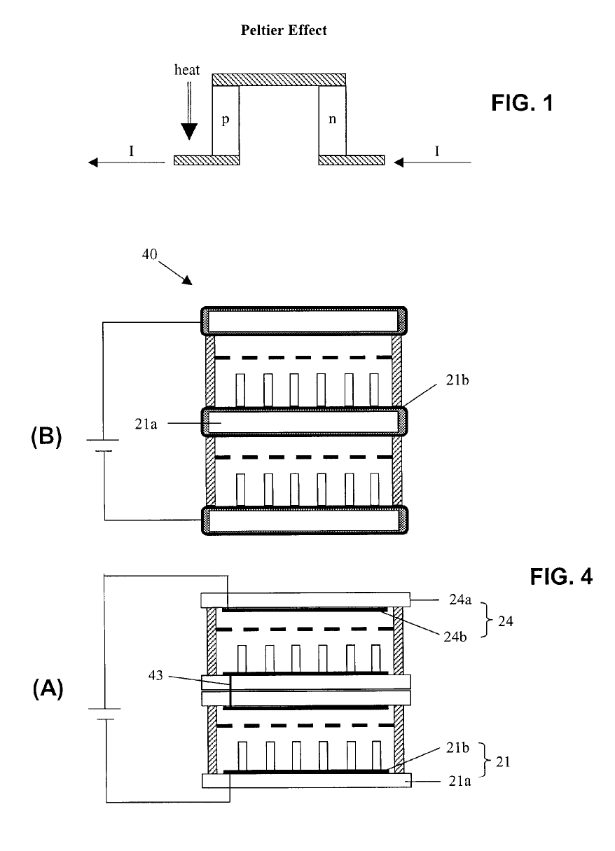

### DETAILED DESCRIPTION

Embodiments of the invention relate to apparatus and methods for thermal energy transfer based on nanotube electron emission, electrical, and thermal conductivity properties. Apparatus in accordance with embodiments of the invention may function as nanotube-based coolers (or heater) or nanotube-based power generators.

Carbon nanotubes (CNT) are seamless tubes of graphite sheets with fullerene caps. CNT were first discovered as multi-layer concentric tubes (i.e., multi-walled carbon nanotubes, MWCNT). Subsequently, single-walled carbon nanotubes (SWCNT) were prepared in the presence of transition metal catalysts. Embodiments of the invention may use SWCNT, MWCNT, or a mixture of the two. CNT have shown promising potentials in applications including, for example, nano-scale electronic devices, high strength materials, electron field emission, tips for scanning probe microscopy, and gas storage.

Main approaches to the synthesis of CNT include: laser ablation of carbon, electric arc discharge of graphite rod, and chemical vapor deposition (CVD) of hydrocarbons. See U.S. Pat. No. 6,333,016 B1 issued to Resasco et al. and references cited therein. Among these approaches, CVD coupled with photolithography has been found to be the most versatile in the preparation of various CNT devices. In a CVD method, a transition metal catalyst is deposited on a silicon wafer in the desired pattern, which may be fashioned using photolithography followed by etching. The silicon wafer having the catalyst deposits is then placed in a furnace in the presence of a vapor-phase mixture of, for example, xylene and ferrocene. Carbon nanotubes typically grow on the catalyst deposits in a direction normal to the substrate surface. Various carbon nanotube materials and devices are now available from commercial sources, including Molecular Nanosystems (Palo Alto, Calif.) and Bucky, USA (Houston, Tex.).

An improved CVD method was recently reported by Wei et al. in “Organized Assembly of Carbon Nanotubes,” Nature, 416, pp. 495-496, Apr. 4, 2002, which discloses methods for preparing carbon nanotubes on silica (SiO₂) and silicon surfaces without using a transition metal catalyst. According to this method, areas of silica (SiO₂) are patterned on a silicon wafer, by photolithography and etching. Carbon nanotubes are then grown on the silica (SiO₂) areas in a CVD or a plasma-enhanced CVD (PECVD) process. These methods permit the production of carbon nanotube bundles in various shapes. Carbon nanotubes suitable for embodiments of the invention may be prepared according to this method.

As noted above, carbon nanotubes have unique physical and electrical properties. As electron field emitters, carbon nanotubes have the characteristics of low work function, durability, and thermal stability. See Dean et al., “Carbon Nanotube Field Emission Electron Source,” New Diamond and Frontier Carbon Technology, vol. 12, No. 4, (2002). Accordingly, an electron field emitter based on CNT can be driven at relatively low voltages. In addition, the chemical resistance of such devices to reactions with gases, which may be generated during the operation of the device, is improved, thereby increasing the life span of the emitters. Examples of the use of CNT as electron field emitters and the methods of preparing CNT-based field emission arrays, for example, may be found in U.S. Pat. No. 6,440,761 issued to Choi.

CNT-based field emitters in the prior art are often used as cold cathode displays, which may replace the conventional cathode ray tubes (CRT). See e.g., U.S. Pat. No. 6,664,727 B2 issued to Nakamoto and Kim et al., “Full Color, Large Area Field Emission Displays Using Carbon Nanotube Emitters,” EUROFE 2000, Sep. 25-19, 2000, Segovia, Spain. In contrast, embodiments of the invention relate to the use of carbon nanotube electron emitters in thermal management. In accordance with embodiments of the invention, hot electrons are emitted by the carbon nanotubes and travel to an anode. In the process, heat is removed from the “cathode” to the “anode,” much like a Peltier cooler or the Cool Chip™.

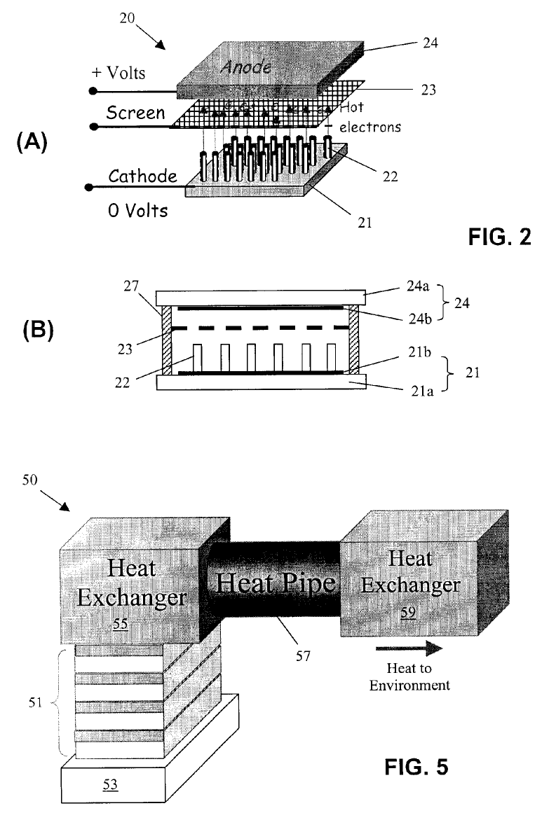

FIGS. 2A and 2B illustrate a schematic of a carbon nanotube-based cooler or heat transfer device (“nano-cooler”) in accordance with one embodiment of the invention. As shown in FIG. 2A, main components of a nano-cooler 20 include a substrate layer 21 having nanotube bundles 22 attached thereon and an electron capture plate (“anode plate”) 24. The nano-cooler 20 may optionally include a screen grid (“screen electrode”) 23. The functions of screen grid 23 will be explained in more detail in the following section. Hot electrons are emitted from the ends of carbon nano-tubes 22 when an electrical potential (bias potential) is applied across the substrate layer 21 and the anode plate 24, as shown in FIGS. 2A and 2B. In this nano-cooler, hot electrons emitted from carbon nanotubes cool the cathode (substrate layer 21 in FIG. 2) and transfer heat to the anode plate (shown as 24 in FIG. 2).

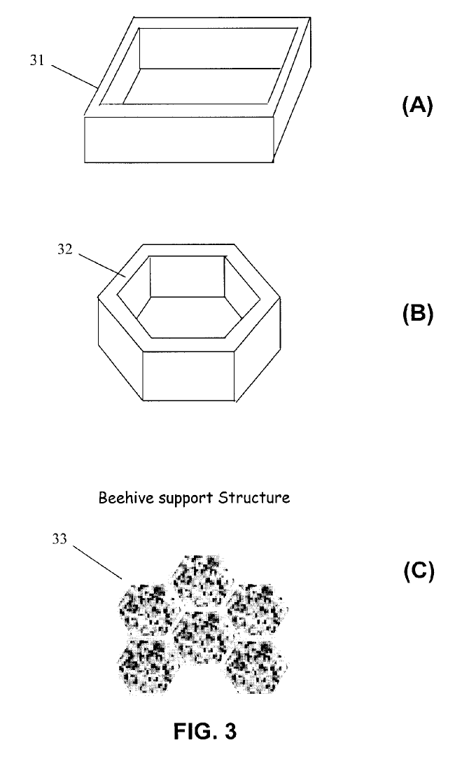

FIG. 2B shows a cross sectional view of a nano-cooler in accordance with one embodiment of the invention. In this view, the substrate layer 21 with the nanotubes 22, the screen grid 23, and the anode plate 24 are assembled with an enclosure 27, which will be explained further with reference to FIG. 3. As shown, the substrate layer 21 comprises a base layer 21a and a conductive layer 21b. In some embodiments, the substrate layer 21 may comprise a single conductive layer (i.e., the base layer 21a and the conductive layer 21b are made of the same conductive material). Similarly, the anode plate 24 comprises a base layer 24a and a conductive layer 24b. In some embodiments, the anode plate 24 may comprise a single conductive layer (i.e., the base layer 24a and the conductive layer 24b are made of the same conductive material). In some embodiments, the base layer 24a and the conductive layer 24b are fabricated of a metal film such as nickel. The conductive layers 21b, 24b are configured to connect to a power source (not shown) to provide a bias potential to facilitate the emission of electrons from the nanotubes 22 and to facilitate the emitted electrons to travel to the anode plate 24.

Because the substrate layer 21 is adapted to conduct heat from the object to be cooled, the base layer 21a is preferably a good heat conductor. In some embodiments, the base layer 21a is made of a good heat conductor that does not conduct electricity, such as ceramic. In some embodiments, the base layer 21a is made of a good conductor for both heat and electricity, such as metal. Similarly, the base layer 24a is preferably a good heat conductor. In addition, the substrate layer 21 may adapt a configuration for optimal contact with the object to be cooled.

The layer of carbon nanotubes 22 preferably comprises an ordered array of parallel carbon nanotubes (CNT). These carbon nanotubes can be either single-walled (SWCNT) or multi-walled (MWCNT), or a mixture of the two. Both MWCNT and SWCNT can be manufactured to have narrow size distributions, large-scale periodicities, and high array densities. These attributes make it possible to manufacture a stable, predictable, and uniformly dense electron emitter.

In accordance with embodiments of the invention, gaps between the substrate layers 21 and the anode plates 24 are on the order of a few micrometers (μm) to a few millimeters (mm), preferably on the order of 10-100 micrometer (μm). A nano-cooler in accordance with embodiments of the invention is preferably sealed in vacuum. However, the vacuum requirement for the nano-cooler is less stringent than a conventional vacuum tube (or cathode ray tube; CRT) because carbon nanotubes are less influenced by the atmosphere or residual gas. The voltage required for the nanotubes to emit electrons to anode is low, typically a few volts per μm gap (e.g., 1-5 V/μm). See e.g., U.S. Pat. No. 6,605,894 B2 issued to Choi et al. Thus, a nano-cooler in accordance with the invention may require a voltage on the order of about 100 volts to operate. This voltage requirement can be further reduced if the nano-cooler includes a control or screen grid 23.

In accordance with embodiments of the invention, a screen grid 23 may be maintained at an appropriate voltage to assist electron emission from the carbon nanotubes 22 and to assist the emitted electrons to reach the anode plate 24. In this particular embodiment that includes the screen grid 23, the structure of the nano-cooler is similar to a cathode ray tube or vacuum tube. One of ordinary skill in the art would appreciate that the potential of the screen grid 23 may be regulated to lower the bias potential needed for electron emission from the carbon nanotubes. In addition, the screen grid potential may be used to turn the electron emission on and off (i.e., as in the control grid of a vacuum tube to regulate electron emission or to pulse electron emission). One of ordinary skill in the art would appreciate that an additional electrode, e.g., the suppressor grid in a vacuum tube, can be introduced and appropriate voltage control can be applied to it in order to reduce, or suppress, the return of electrons from the anode plate back to the cathode, a phenomenon known as “secondary emission” (see Spangenburg, K. R., Fundamentals of Electron Devices, McGraw-Hill, 1957 or see Valley, G. E. & Wallman, H., Vacuum Tube Amplifiers, MIT Press, 1946, reprinted by Boston Technical Publishers Inc., 1964). Furthermore, in the nano-cooler, the screen grid 23 may also be used to control the electron flow to optimize the device's performance or to operate more than one device in a series or parallel combination of circuits.

The nano-cooler 20 shown in FIG. 2A and FIG. 2B will typically be enclosed in a mechanically supporting structure and package made of an electrically and thermally insulating material, such as silicon-dioxide, ceramic, or fiberglass. The enclosure may have any suitable configuration, such as a rectangle 31 or a hexagon 32 shown in FIG. 3A and FIG. 3B, respectively. The enclosures shown in FIGS. 3A and 3B are for illustration only. Embodiments of the invention may use enclosures having other shapes. In some embodiments, the substrate layer 21 and the anode plate 24 may rest against the top and bottom of the enclosure (see FIG. 2B). In such embodiments, the heights of the enclosure defines the distance between the substrate layer 21 and the anode plate 24; this distance in turn defines the gap between the tips of the carbon nanotubes 22 and the anode plate 24 (see FIG. 2B).

A single nano-cooler cell 20 shown in FIG. 2B may have a cell dimension from a few μm to a few mm, with a typical dimension (length, width, and height) on the order of about 100 μm. A cell or a nano-cooler cell as used herein refers to a simple nano-cooler building block for constructing an “aggregate” nano-cooler assembly. In order to transfer a sufficient amount of heat, a plurality of these nano-cooler cells may be arranged side-by-side to provide a large area for heat transfer. If each nano-cooler is enclosed in a rectangular enclosure (shown in FIG. 3A), then the “aggregate” nano-coolers may look like a typical column and row arrangement. If the nano-cooler cell is enclosed in a hexagon (shown in FIG. 3B), then the aggregate structure will look like a beehive 33 shown in FIG. 3C. Note that these are examples of how to arrange the nano-coolers of the invention to provide a large scale heat transfer device. One of ordinary skill in the art would appreciate that embodiments of the invention are not limited by any particular shape or arrangement of the nano-cooler cells.

In addition to arranging the nano-cooler cells side-by-side (i.e., in parallel) to increase heat transfer, the nano-cooler cells may also be arranged in series to increase the efficiency per area. FIG. 4A illustrates how two or more nano-cooler cells shown in FIG. 2B may be stacked to produce a thermopile to achieve a desired voltage-current characteristic (V-I characteristic). In this embodiment, the conductive layer 24b of the bottom nano-cooler is connected via a conductive link 43 to the conductive layer 21b on the substrate layer of the top nano-cooler. The conductive link 43 may be accomplished by any means known in the art, for example a wire, a via, or a plated through hole (PTH). Note that the location of the conductive link 43 shown in FIG. 4A is for illustration only and should not limit the present invention. A bias potential may then be applied across the bottom nano-cooler (via the conductive layer 21b on the substrate layer) and the top nano-cooler (via the conductive layer 24b on the anode layer) to induce electron emission from the bottom nano-cooler to the intermediate layers and finally to the top nano-cooler. While FIG. 4A shows only two nano-coolers stacked in series, more may be stacked in series to achieve the desired I-V characteristics.

FIG. 4B shows another embodiment of the invention having stacked nano-coolers. In this embodiment, the substrate layer 21 has conductive layers 21b on both surfaces, or wrapped around the base layer 21a. With this modification, multiple nano-coolers may be stacked in series without having conductive links (shown as 43 in FIG. 4A).

With the nano-coolers stacked in series, thermal electrons emitted by the first nano-cooler are passed along the various nano-coolers in the series. In each step along the series, the electrons will carry some heat forward. Therefore, the serial nano-cooler stack can produce a larger temperature drop. Note that embodiments of the invention may use a plurality of nano-coolers in parallel, in series, or a combination of the two.

Some embodiments of the invention relate to the use of the nano-coolers in a heat exchanger or thermal management system. FIG. 5 illustrates one example of a heat exchanger system that includes nano-coolers of the invention. As shown, the heat exchanger system 50 comprises an assembly of nano-coolers 51 disposed between a heat producing source 53 and a heat exchanger 55. The heat exchanger 55 may directly dissipate heat into the environment or to another heat sink. In some embodiments, the heat from the heat exchanger 55 may be carried away by a heat pipe 57 to another heat exchanger 59 for dissipation. The heat pipe 57 may use fluid or gas to carry the heat from the heat exchanger 55 to heat exchanger 59. The heat exchangers and heat pipes used in these embodiments may be conventional components or micro-machined heat transfer devices. See e.g., Selby et al., “Fabrication of Mesoscopic, Flexible, High Pressure, Microchannel HeatExchangers (MHEx),” Transactions of NAMRI/SME vol. XXIX, 2001. In any case, heat transfer devices should not limit the present invention.

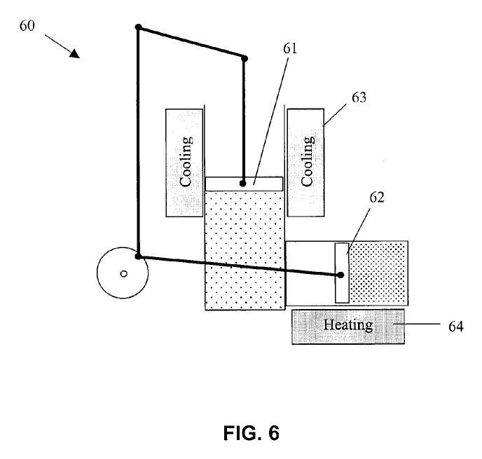

Some embodiments of the invention relate to heat-driven engines powered by pulsing the nano-coolers. Heat-driven engines, such as Sterling engines, are known in the art. Various configurations of Sterling engines are available. FIG. 6 shows one embodiment of a Sterling engine 60 having two pistons 61, 62. Other types of Sterling engines may use a piston and a displacer, or other mechanisms. A Sterling engine works by heating and cooling a gas in a pulsed manner. The cooling mechanism 63 and the heating mechanism 64 may comprise nano-cooler-based heat pumps. In some embodiments, a nano-cooler-based heat pump may be connected, directly or indirectly through intermediary heat exchangers and heat pipes, to the heating mechanism 64 at one end and to the cooling mechanism 63 at the other end. In this case, the heat pump will transfer heat from the cooling mechanism 63 to the heating mechanism 64. The Sterling engine shown in FIG. 6 is only for illustration. One of ordinary skill in the art would appreciate that other types of heat-driven engines may also be used without departing from the scope of the invention.

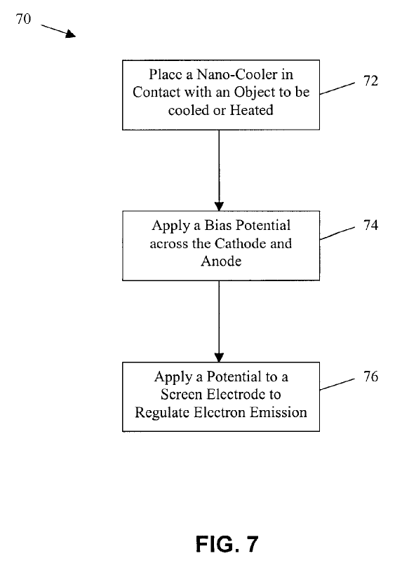

Some embodiments of the invention relate to methods for heat transfer using nano-coolers. FIG. 7 shows a flow chart of a method 70 for heat transfer using a nano-cooler or an assembly of nano-coolers in accordance with one embodiment of the invention. First, a nano-cooler (or an assembly of nano-cooler) is placed in contact with the object to be cooled or heated (step 72). A bias potential is applied across the cathode (the nanotubes containing layer) and the anode (step 74). The method may also include controlling a screen grid potential to regulate electron emissions from the cathode (step 76).

Advantages of embodiments of the invention may include one or more of the following. A nano-cooler of the invention has no moving parts, is fabricated with robust and stable materials, and is therefore more reliable, and can withstand high temperature. A nano-cooler or an assembly of the nano-coolers can be used to cool electronic devices or circuits in tight spaces, for example, on a logging tool or on the downhole electronics in an oil well monitoring and control system. Nano-coolers of the invention may be coupled with conventional heat exchangers or heat pipes to form a thermal management system. In addition, the nano-coolers of the invention may be used to power heat-driven engines, such as a Sterling engine.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A nanotube-based heat transfer device, comprising:
a substrate layer comprising a first conductive layer, wherein the substrate layer is adapted to conduct heat from an object to be cooled;
a plurality of carbon nanotubes disposed on the first conductive layer; and
an anode plate comprising a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes,
wherein the first conductive layer and the second conductive layer are adapted to connect to a power source to provide a bias electrical potential for inducing electron emission from the plurality of carbon nanotubes.

2. The device of claim 1, wherein the selected distance is between about 1 micrometer and about 1000 micrometer.

3. The device of claim 1, wherein the selected distance is about 100 micrometer.

4. The device of claim 1, further comprising a screen electrode disposed between the second conductive layer and the plurality of carbon nanotubes, wherein the screen electrode is configured to control the electron emission.

5. A heat transfer assembly comprising a plurality of nanotube-based heat transfer devices, wherein at least one of the plurality of nanotube-based heat transfer devices comprises:
a substrate layer comprising a first conductive layer, wherein the substrate layer is adapted to conduct heat from an object to be cooled;
a plurality of carbon nanotubes disposed on the first conductive layer; and
an anode plate comprising a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes,
wherein the first conductive layer and the second conductive layer are adapted to connect to a power source to provide a bias electrical potential for inducing electron emission from the plurality of carbon nanotubes.

6. The heat transfer assembly of claim 5, wherein the at least one of the plurality of carbon nanotube-based heat transfer devices further comprises a screen electrode disposed between the second conductive layer and the plurality of carbon nanotubes, the screen electrode is configured to control the electron emission.

7. The heat transfer assembly of claim 5, wherein the plurality of carbon nanotube-based heat transfer devices are arranged in series.

8. The heat transfer assembly of claim 5, wherein the plurality of carbon nanotube-based heat transfer devices are in a side-by-side manner.

9. The heat transfer assembly of claim 5, wherein the plurality of carbon nanotube-based heat transfer devices are arranged in series and in a side-by-side manner.

10. A thermal energy management system, comprising:
a heat transfer assembly comprising a plurality of nanotube-based heat transfer devices; and
a first heat exchanger coupled to the heat transfer assembly;
wherein at least one of the plurality of nanotube-based heat transfer devices comprises:
a substrate layer comprising a first conductive layer, wherein the substrate layer is adapted to conduct heat from an object to be cooled;
a plurality of carbon nanotubes disposed on the first conductive layer; and
an anode plate comprising a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes,
wherein the first conductive layer and the second conductive layer are adapted to connect to a power source to provide a bias electrical potential for inducing electron emission from the plurality of carbon nanotubes.

11. The system of claim 10, further comprising a heat pipe and a second heat exchanger, wherein the heat pipe is coupled to the first heat exchanger and the second heat exchanger to transfer heat from the first heat exchanger to the second heat exchanger.

12. The system of claim 10, wherein the at least one of the plurality of nanotube-based heat transfer devices further comprising a screen electrode disposed between the second conductive layer and the plurality of carbon nanotubes, wherein the screen electrode is configured to control the electron emission.

13. A nanotube-based heat-driven engine, comprising:
an engine comprising a fluid, wherein controlled cooling and heating of the fluid provides energy to run the engine;
a cooling mechanism; and
a heating mechanism,
wherein at least one selected from the cooling mechanism and the heating mechanism comprises a carbon nanotube-based heat transfer device,
wherein the carbon nanotube-based heat transfer device comprising:
a substrate layer comprising a first conductive layer, wherein the substrate layer is adapted to conduct heat from an object to be cooled;
a plurality of carbon nanotubes disposed on the first conductive layer; and
an anode plate comprising a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes,
wherein the first conductive layer and the second conductive layer are adapted to connect to a power source to provide a bias electrical potential for inducing electron emission from the plurality of carbon nanotubes.

14. The nanotube-based heat-driven engine of claim 13, wherein the engine is a Sterling engine.

15. The nanotube-based heat-driven engine of claim 13, wherein the carbon nanotube-based heat transfer device further comprises a screen electrode disposed between the second conductive layer and the plurality of carbon nanotubes, wherein the screen electrode is configured to control the electron emission.

16. A method for heat transfer, comprising:
placing a carbon nanotube-based heat transfer device in contact with an object,
wherein the carbon nanotube-based heat transfer device comprises:
a substrate layer comprising a first conductive layer, wherein the substrate layer is adapted to conduct heat from the object;
a plurality of carbon nanotubes disposed on the first conductive layer; and
an anode plate comprising a second conductive layer, wherein the anode plate is arranged substantially parallel to the substrate layer with the second conductive layer facing the first conductive layer, wherein the second conductive layer is disposed at a selected distance from the first conductive layer such that a gap exists between the second conductive layer and the plurality of carbon nanotubes,
wherein the first conductive layer and the second conductive layer are adapted to connect to a power source to provide a bias electrical potential for inducing electron emission from the plurality of carbon nanotubes; and
applying a bias electrical potential across the first conductive layer and the second conductive layer of the carbon nanotube-based heat transfer device to induce electron emission from the plurality of the carbon nanotubes.

17. The method of claim 16, further comprising controlling a potential of a screen electrode disposed between the second conductive layer and the plurality of carbon nanotubes of the carbon nanotube-based heat transfer device.
